(19) United States
(12) Patent Application Publication
(10) Pub. No.: US 2009/0218502 A1
(43) Pub. Date: Sep. 3, 2009

(54) BETA-RADIATION DETECTOR FOR BLOOD FLOW AND CHROMATOGRAPHY

(76) Inventors: Jan Axelsson, Uppsala (SE); Harald Schneider, Uppsala (SE)

Correspondence Address: GE HEALTHCARE, INC., IP DEPARTMENT 101 CARNEGIE CENTER, PRINCETON, NJ, 08540-6231, US

(21) Appl. No.: 12/279,738

(22) PCT Filed: Feb. 19, 2007
(86) PCT No.: PCT/IB07/00401

§ 371 Date: Apr. 2, 2009

Related U.S. Application Data
(60) Provisional application No. 60/774,340, filed on Feb. 17, 2006.

(51) Int. Cl. G01T 1/20

(52) U.S. Cl. 250/370.11

(57) ABSTRACT

A detection device for beta radiation includes first and second adjacent detectors and a coincidence counter unit. The same beta particle may be counted twice. Alternatively, one or more positrons may be detected along with one or more gamma photons.

### FIELD OF THE INVENTION

The present invention is directed to the field of detectors for blood flow and chromatography. More specifically, the present invention relates to a low background beta radiation detector.

### BACKGROUND OF THE INVENTION

The art knows that the basis for detection of a beta emitting nuclei is a nucleus emitting a beta particle (electron or positron) with some kinetic energy. The beta particle will “bounce” around the electric charges in the matter, and will share its kinetic energy mainly interacting with electrons. In the case of emitted positrons, the probability that the positron, which is the anti-matter to an electron, will be annihilated when coming close to an electron increases as the positron's kinetic energy goes down, and at some point the positron and an electron will annihilate and their mass will be converted to two gamma photons each of 511 keV energy. The distance that a positron travels from the nucleus to the point of annihilation may vary, but is described by a typical range which is of the order of a millimeter.

Positron Emission Tomography (PET) is a technique where the distribution of positron emitting nuclei in a body is detected by measuring the pair of annihilation gamma photons, typically in a ring shaped detector configuration, and reconstructing the pair-wise detected events using tomographic techniques. See, Timothy G. Turkington, J Nucl Med Technol, 29 (2001) 4-11. Prior to, or during the PET scan, a patient or animal is injected by a radioactively labeled molecule. This causes the patient to be the highest radiation source in the room, which will cause difficulties for the signal quality in the below mentioned devices.

Detection of radioactivity in blood is useful so that modeling of a patient's or animal's response to (radioactively labeled) injected molecules can be performed. Modeling is typically performed by assuming a number of different compartments, with unknown rate constants going in and out of each compartment. Intensity distributions from the images of a PET study may, via modeling, be translated to such characteristics as transport rates, metabolic rates, receptor occupancy etc. Since molecules are transported in the blood system, the blood system acts as the input to a response model, and is thus necessary to measure.

Often, the plasma concentration is the interesting input function, whereas continuous blood measuring systems only measure the whole-blood radioactivity. Therefore a number of discrete samples are taken and centrifuged to measure both the whole-blood and plasma concentrations. Moreover, if the molecule is metabolized by the patient, chromatographic separations must also be performed on the discrete samples, before measuring the radio-activity of chromatographic fractions. These discrete measures are then combined with the continuously-measured whole-blood activity to yield a continuous plasma input function.

Discrete samples are analyzed by putting an extracted sample in a well crystal counter. The counter is formed from one or more scintillating crystals forming a cylindrical detector, each crystal connected to a photo-multiplier tube. The scintillating material (typically NaI, BGO, LSO) lights up when a gamma ray strikes and the photo-multiplier tube converts the light to an electric pulse which can be counted. Counting is typically performed “in coincidence” with the pulses from two detectors, so that an event is only registered if both detectors give a pulse within a very short time window (ranging, e.g., from nanoseconds to a microsecond). Coincidence counting is used to discriminate background events. The setup normally uses two half-moon shaped cylinder halves, where each half feeds light to one photo-multiplier tube.

Continuous blood sampling typically involves (a) continuously tapping arterial or venous blood through a catheter from a patient or animal at a controlled flow rate of the order of 5 ml/min, employing a syringe pump or peristaltic pump; (b) positioning the catheter in a detector configuration designed so that collection of radiation from the catheter is maximized and collection of radiation from outside the catheter is minimized; and (c) using the detector and electronic system to analyze the radiation to minimize the detection of radiation from outside the catheter (typically single 511 keV gamma photons) while maximizing the detection of events from inside the catheter (typically the simultaneous absorption of two 511 keV gamma photons).

It is desirable to measure the radio-activity in the continuous blood with a catheter length being as short as possible, to minimize dispersion of the signal, especially in the initial state following injection of radioactivity to the subject patient/animal.

Several known principles, or methods for detection, will now be examined, referring to Table 1.

TABLE 1

| | | in/out-side | | total | | | | |
|---|---|---|---|---|---|---|---|---|
| | Reference, technique | body | coincidence | energy | scintillator | quantas | beta | gamma |
| a | Eriksson, commercially implement | outside | X | | X | 2 | | X |
| | as Scanditronix blood sampler | | | | | | | |
| b | Eriksson 2, Allogg blood | outside | | X | X | 2 | | X |
| c | PET image | outside | X | | X | 2 | | X |
| d | Senda | outside | | | X | 1 | | X |
| e | Besret, beta microprobe | inside | | | X | 1 | X | |
| | (inserted into blood vessel) | | | | | | | |
| f | IN/US, Radiochromatography | outside | | X | X | 2 | | X |
| g | IN/US, Radiochromatography | outside | | X | X | 1 | X | |
| h | IN/US, Radiochromatography | outside | X | | X | 2 | | X |

Explanation to column headings:
In/out-side body = if detector is put inside blood vessel or if blood is taken out via a catheter to pass through the detector outside the body (this is most common).
Coincidence = if coincidence is used to give signal only if two quantas (normally gamma photons) are detected simultaneously
Total energy = if total deposited energy is analyzed instead of coincidence
Scintillator = if a scintillator is used (if not silicon based techniques such as PIN-diodes may be used)
Quantas = Sum of number of quantas, that is sum of 1 or 2 gamma photons and 0 or 1 positron. The most likely case of 2 photons from a positron annihilation is assumed in this table. In the case of 3 photon in the annihilation process add 1 to the number.
Beta = if positron is detected
Gamma = if one or more gamma photons are detected

The first principles described in Table 1, in rows a-d, employ a detector principle where a scintillating crystal, such as for instance BGO, LSO, NaI, converts the gamma photon to a large number of photons. The process follows the steps:
“Compton scattering” of the gamma photon with an electron in which the gamma photon gives an electron in the crystal kinetic energy while being converted to a gamma photon of lower energy. This process may take place a multitude of times, and
kinetic energy gained by the electrons will be absorbed by the crystal within a very short time, causing short-lived (life-time being crystal dependent) excited electronic states which will relax and emit near-visible or visible light.
A fraction of the light goes into a photo-multiplier tube through one of the faces of the crystal. A fraction of the photons create emission of primary electrons from the cathode surface. The primary electron signal is amplified by sequential acceleration over high voltage gaps and secondary electron emission from anodes, causing an avalanche of secondary electrons.
A final anode collects an electron pulse with the charge being proportional to the energy of the gamma photon or photons that initially entered the scintillator.

More specifically, the prior art represented in Table 1 may be described as follows (using the annotation of Table 1x, where x denotes the row of Table 1 being described):
Table 1a: Continuous blood sampler detectors often work along the same principle as the well-crystal counter. The light yield from two detectors is analyzed for coincidence events (two gammas detected within a narrow time interval in both detectors), and only coincidence events are counted. See Eriksson L, Holte S, Bohm Chr, Kesselberg M, Hovander B, IEEE Trans Nucl Sci, 1998 February, 35, 703-707 (hereinafter “Eriksson”). One commercial implementation of such a detector features lead shielding on only one side, which works if the detector is always facing the same way with the shield between the external radiation from the patient. From experience, it has been seen that it is easy to get wrongly acquired blood activities due to misalignment of the detector, or a source of radiation which has not been considered.
Table 1b: An alternative continuous blood sampler detector employs a single scintillator crystal, where the light output from the one crystal is analyzed for total detected light output (which can be calibrated to a known energy scale). The total energy of two simultaneous gamma photons is 1022 keV, which is easily distinguished from that of a single gamma photon of 511 keV. See L Eriksson, M. Ingvar, G. Rosenqvist, S. Stone-Elander, T. Ekdahl, P. Kappel, IEEE Transcations on Nuclear Science, vol. 42, No. 4, August 1995, pp 1007-1011 (hereinafter “Eriksson 2”).
Table 1c: It is conceptually possible to place the animal or patient within the detector, that is, using the PET scanner as a detector. If a blood volume a few times larger than the resolution of the PET scanner is present in the field-of-view of the scanner, the radioactivity in the blood flow can be measured directly. See Sörensen J. Stahle E, Långström B, Frostfeldt G, Wikström G, Hedenstierna G, J Nucl Med, 2003 July, 44: 1176-1183. This is often impractical, since the only place which fulfills this criterion is the heart, which is seldom within the field-of-view of the PET scan during the complete examination. Due to the limited resolution of the PET scanner, measuring of other blood volumes, such as the aorta, gives problems with activity “spill over” from outside the vessel. See Dhawan V, Takikawa S, Robeson W, Spetsieris P, Chaly T, Dahl R, Zanzi I, Bandyopadhyay D, Margouleff D, Eidelberg D. Quantitative brain FDG/PET studies using dynamic aortic imaging. Phys Med Biol. 1994; 39(9):1475-1487.
Table 1d: One technique, described in Senda M, Nishizawa S, Yonekura Y, Mukai T, Saji H, Konishi J, Torizuka K. Measurement of arterial time-activity curve by monitoring continuously drawn arterial blood with an external detector: Errors and corrections. Ann Nucl Med. 1988 May; 2(1):7-12, uses 8 cm of lead shielding to stop background radiation. This system only detects half of the gamma radiation since it exhibits a single scintillating crystal positioned on one side of the catheter.
Table 1e: In the only one the techniques of Table 1 which insert the probe directly into the blood flow, described in Besret L, Pain F. Blood input function measurements with the β microprobe. Biospace Mesures, 10 Rue Mercoeur, F-75011 Paris, France, a Beta-microprobe uses a scintillating detector, positioned at the end of an optical fiber, which is inserted into the blood vessel of the patient/animal. This technique typically detects events by the direct conversion of the kinetic energy of the positrons before annihilation to form the gamma photons. Drawbacks with this method include the small detection volume which gives low signal to noise ratio, and the resultant medical problems which may be caused by the detachment of a minute scintillating crystal from the end of the fiber. This method is mostly useful for animals where the existence of a minute medical risk is a less significant problem and where a higher administered radioactive dose is allowed.
Table 1f, 1g, 1h: Chromatographic techniques of radioactive compounds often employ continuous measures of a fluid passing through a capillary. Therefore, the detection methods for this analysis technique are relevant to continuous blood sampling. There exist commercially available in-line detectors for both beta and gamma emitting nuclei. See, e.g., IN/US Systems Radiochromatography Detectors Product Information, www.inus.com. The principle for direct beta (positron or electron) detection is to have either a scintillating fluid, or to have a scintillating surface of the flow-through detector (Table 1g). For gamma detection a system similar to the Eriksson or Eriksson 2 method are used, depending on if the gamma is direct (Table 1f) or in coincidence (Table 1h) as caused by positron annihilation.

All detection systems discussed in Table 1 employ a threshold technique, in which all signals that are below a set threshold level are discarded.

Several problems are known to exist with the prior art. Most of the techniques require shielding, employing a high density material such as lead, which ideally has to be fitted around the detector in all directions. The implementation of so much shielding causes the system to weigh of the order of 50-100 kg. Accidents involving dropping of the detector can easily happen, causing serious injuries to the operator or patient. One solution is to use lead only in one direction, but this renders the system susceptible to false counts such as from somebody passing by with radioactivity on the wrong side, or a faulty alignment of the detector relative the patient or due to bad positioning of the radioactive waste blood. The added weight thus requires centering the detector on a steady cart with a wide base, thereby frustrating the need to place the heavy detector close to the patient. The alternative approach to measure activity within the artery using a minute scintillator is indeed a light-weight approach, but suffers from limited signal to noise ratio, due to the sensitivity to noise from the high flux of gamma photons in the near vicinity of the patient.

Thus, there is a need in the art for a light-weight detector which can be placed very close to the patient and which efficiently can remove false counts from background activity. All the above-identified shortcomings of prior art are addressed by the present invention.

### SUMMARY OF THE INVENTION

In view of the needs of the prior art, the present invention provides a detection device for beta radiation having first and second adjacent detectors and a coincidence counter unit. Each of the first and second detectors are coupled to the coincidence counter unit.

### BRIEF DESCRIPTION OF THE DRAWINGS

FIG. 1 depicts a beta-beta detector of the present invention.

FIG. 2 depicts a flow-cell incorporating a beta-beta detector of the present invention.

FIG. 3 depicts a front elevational view of the flow cell of FIG. 2.

FIG. 4 depicts an alternate flow-cell incorporating the beta-beta detector of the present invention.

FIGS. 5 and 6 depict a coincidence beta-beta-gamma detector of the present invention.

FIGS. 7 and 8 depict a coincidence beta-beta-gamma-gamma detector of the present invention.

FIGS. 9 and 10 depict a coincidence beta-gamma detector of the present invention.

FIGS. 11 and 12 depict a coincidence beta-gamma-gamma detector of the present invention.

### DETAILED DESCRIPTION OF THE PREFERRED EMBODIMENT

The present invention takes the approach of directly detecting parts of the positron kinetic energy following its passing of two detectors summed at a coincidence counter. Desirably, the detectors are in the form of thin planar silicon diodes. Thin diodes have a low probability of detecting gamma photons due to gamma radiation's comparatively low probability of interacting with matter, but are almost certain to detect the deposited kinetic energy from the positron due to beta particles high probability of interaction. The two signals from the diode detectors are fed through a coincidence unit to discard signals detected in only one of the detectors, thus diminishing the risk of detecting the low probability gamma photons. Desirably, the detector should be sufficiently thin to allow a large fraction of the positron's energy to be retained while passing through each detector, and to allow a high probability for passing without annihilation.

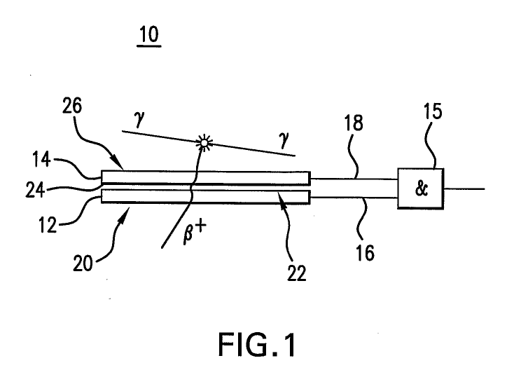

FIG. 1 depicts a detector 10 of the present invention. Detector 10 generates an output signal only if energy above a threshold level is deposited in each detector, within a short time window. Forcing the above limitations, called coincidence detection, is significant to lower counts from adjacent background sources. Detector 10 includes a detector diode 12, a second planar diode 14, and a coincidence counter 15, and first and second output lines 16 and 18 extending between coincidence counter 15 and first and second diodes 12 and 14, respectively. Diode 12 includes opposed major surfaces 20 and 22. Diode 14 includes opposed major surfaces 24 and 26. The present invention contemplates that major surfaces 22 and 24 may be in spaced overlying registry or in abutting contact.

Alternatively, the detector can be made of a thin scintillating crystal optically coupled to a light-sensitive device such as a photo-multiplier, or a semi-conducting diode. The range for positrons is for many isotopes of the order of a millimeter, which is compatible with, for instance, the 0.3 mm thickness of the Hamamatsu S3588-09 large area diode. With this diode, only 1% of gamma photons above 150 keV are detected (see, e.g., Ramsey, http://www.carroll-ramsey.com/detect.htm quoting Silicon Photodiodes and Charge Sensitive Amplifiers for Scintillation Counting and High Energy Physics Hamamatsu Photonics K.K., Solid State Division, Catalog #KOTH0002E02, June, 1993). For other beta emitting isotopes, the detector thickness must be thinner.

The present invention contemplates a flow-through cell incorporating two thin solid state (thickness in the order of 0.01-2 millimeters) detectors. The detectors are desirably in the form of semi-conducting diodes or transistors. It will be appreciated that the diodes may be formed from silicon, although any suitable semi-conducting material may be used. Alternatively, the detectors may include pieces of scintillating material (thickness in the order of 0.01-2 millimeters) attached to the semi-conducting detectors so that the detectors are sandwiched together, thus minimizing unnecessary path length for the beta particle. It is not necessary that the two detectors are in an abutting relationship as there may be some air or low-density material provided therebetween. Geometrical considerations, however, suggest the desirability of placing each of the detectors in close proximate overlying registry. A catheter can be attached to this flow-through cell and to the patient/animal.

Obviously, the detector of the present invention is also useful as a detector for a much wider application field, e.g., for chromatographic applications.

To make the detector as sensitive as possible, it could be incorporated into the wall of a flow-through cell so that unnecessary passage through catheter walls is removed.

It is further contemplated by the present invention that the detection of a positron may be combined with the detection of one or both of the annihilation gamma photons. In this setup, either one or several passages of a single positron can be detected in coincidence with one or two gamma photons, where gamma photons are detected through one or more additional gamma photon detectors, such as for instance a scintillator or a thick semi-conducting device known for detecting gamma photons, which is also connected to the coincidence counter 15.

The description will focus on positron detection, which is a more difficult problem than electron detection since annihilation photons from background in patient or animal may be present in large quantities.

Two or more detectors are placed adjacent to each other in a design that allows a fraction of the kinetic energy of a positron to be deposited in each detector. Keeping the detector thickness small lowers the probability for gamma detection, while still a sizeable fraction of the positron's kinetic energy will be detected.

The following demonstrates the capacity of the present invention to discriminate background events:
Assume 200 MBq being collected in a body 30 cm away from the detector. For simplicity, assume this body to be a point source, without any attenuation of gamma photons.
Use two 30*3 mm² Hamamatsu S3588-09 large area diodes on top of each other.
The fraction of the 200 MBq gammas that will impinge on the detector area is the ratio of the diode area A_{d} to the area of a sphere Aₛₚₕₑᵣₑ with radius 30 cm,

$$\frac{{A}_{d}}{{A}_{sphere}} = \frac{3 \cdot 30 {mm}^{2}}{4 π {r}^{2}} = \frac{90 \cdot {10}^{- 6} {m}^{2}}{4 π \cdot {0.3}^{2} {m}^{2}} = 8 \cdot {10}^{- 5}$$

Thus, with a rate single gamma photons of 2 times 200 MBq (two annihilation photons), that is 400 MBq, 31000 photons per second will pass through the detector.
With a 1% gamma detection efficiency, N₁ and N₂=310 counts per second will be registered in each single detector.
Using a coincidence window σ of 1 us, results in a count of

σN₁N₂=1·0⁻⁶·310·310=0.1 counts/s
random coincidence events from gammas.

Several factors can be used to reduce the random events further:
Shorter coincidence window
Thinner detectors
Lead shielding (13 mm reduces gamma 10 fold in each detector)
Moving the detector further away from external radiation

Thus, the capacity of this invention to discriminate noise is tremendous even without any shielding.

We have experimentally verified that with two Hamamatsu S3588-09 large area diodes on top of each other, positrons from Gallium 68 decay do reach the second diode through the first diode.

In summary, using the conventions of Table 1, Table 2 shows how the following principles are covered in the different implementations of the present invention:

TABLE 2

| | in/out-side | | Total | | | | |
|---|---|---|---|---|---|---|---|
| Not previously known: | body | coincidence | energy | scintillator | quantas | beta | gamma |
| Double-detect same positron (beta-beta) | outside | X | | | 1 | X | |
| Coincidence beta-gamma | outside | X | | | 2 | X | X |
| Coincidence beta-gamma-gamma | outside | X | | | 3 | X | X |
| Coincidence beta-beta-gamma | outside | X | | | 2 | X | X |
| Coincidence beta-beta-gamma-gamma | outside | X | | | 3 | X | X |

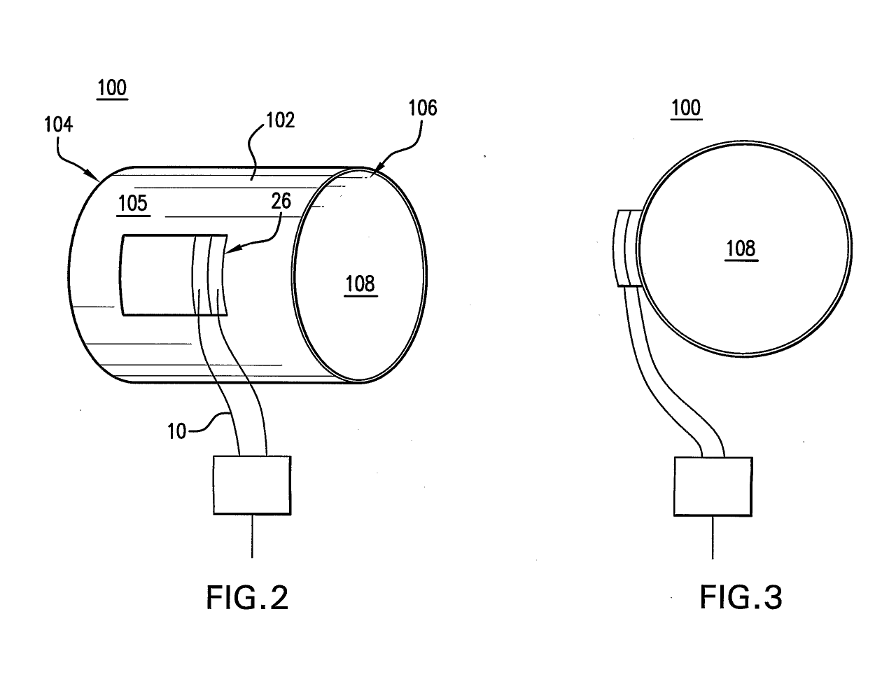

FIGS. 2 and 3 depict a flow-cell 100 incorporating a beta-beta detector 10 of the present invention. Flow-cell 100 includes an elongate conduit 102 having first open end 104, second open end 106 and defines an elongate passageway 108 extending therebetween. Flow-cell 100 may be placed in fluid communication with a source of blood, or any other fluid to be studied, so as to allow the blood (or alternate fluid) to flow through passageway 108 towards its final destination. Conduit 102 includes a cylindrical outer surface 105. Additionally, conduit 102 is desirably formed from a material which is transmissive to both beta and gamma radiation. Planar face 26 of Detector 10 is positioned against surface 105 for detecting beta particles emitted from the fluid flowing through passageway 108. By use of the term “planar” to describe face 26, it will be understood to mean a generally smooth surface. For example, face 26 is shown in FIG. 1 as a flat, non-curving surface, while in other figures is shown to include a curve to approximate that of the conduit to which it is attached. The present invention contemplates that detector 10 may incorporate either type of surface for surface 26 or 20 and that the beta radiation-detecting diodes have either an arcuate or rectilinear body.

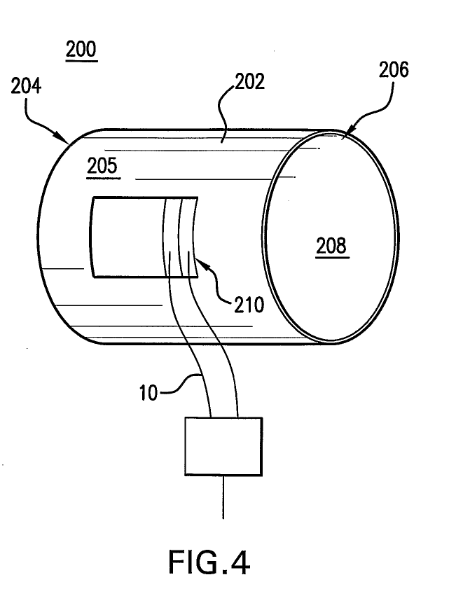

FIG. 4 depicts an alternate flow-cell 200 incorporating the beta-beta detector of the present invention. Flow-cell 200 includes an elongate conduit 202 having first open end 204, second open end 206 and defines an elongate passageway 208 extending therebetween. Flow-cell 200 may be placed in fluid communication with a source of blood, or any other fluid to be studied, so as to allow the blood (or alternate fluid) to flow through passageway 208 towards its final destination. Conduit 202 includes a cylindrical outer surface 205 and defines a window 210 in fluid communication with passageway 208. Window 210 is sized and shaped to accommodate planar surface 26 of detector 10 therethrough so that surface 26 of detector 10 is actually contacting the fluid flowing through passageway 205. Detector 10 is sealed within window 210 so as to prevent fluid leaking out window 210. Conduit 202 is also desirably formed from any material suitable for conducting the fluid of interest.

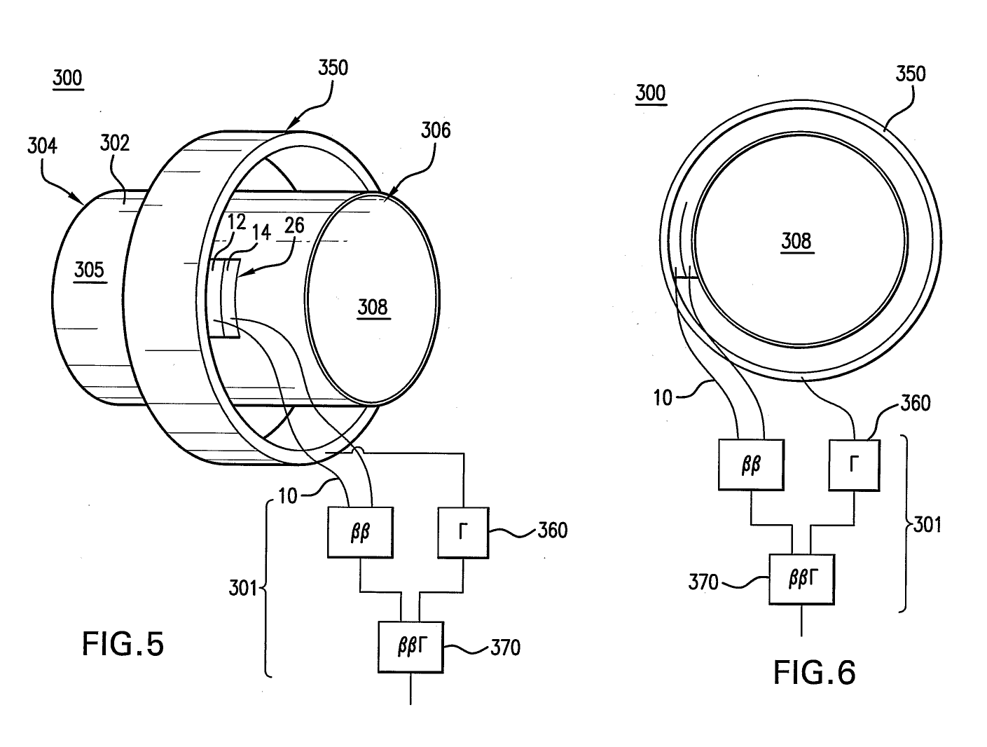

FIGS. 5 and 6 and depict a flow-cell 300 which incorporates a coincidence beta-beta-gamma detector 301 of the present invention. Flow cell 300 includes an elongate conduit 302 having first open end 304, second open end 306 and defines an elongate passageway 308 extending therebetween. Flow-cell 300 may be placed in fluid communication with a source of blood, or any other fluid to be studied, so as to allow the blood (or alternate fluid) to flow through passageway 308 towards its final destination. Conduit 302 includes a cylindrical outer surface 305. Additionally, conduit 302 is desirably formed from a material which is transmissive to both beta and gamma radiation. Planar face 26 of Detector 10 is positioned against surface 305 for detecting beta particles emitted from the fluid flowing through passageway 308.

Detector 301 includes an annular scintillator 350 extending about diodes 12 and 14 of detector 10 and conduit 302. Scintillator 350 is optically coupled to a light-sensitive device 360 such as a photo-multiplier or a semi-conducting diode. Light-sensitive device 360 converts the optical signal from scintillator 350 into an electrical signal which may be detected by a coincidence unit 370. Coincidence unit 370 is also connected to the output of detector 10 so that it can detect the thresholded outputs of detector 10 and device 360 within a time window so as to provide an output signal indicating the beta-beta output of detector 10 and the gamma signal from device 360. Scintillator 350 may alternatively be provided about only a portion of conduit 302.

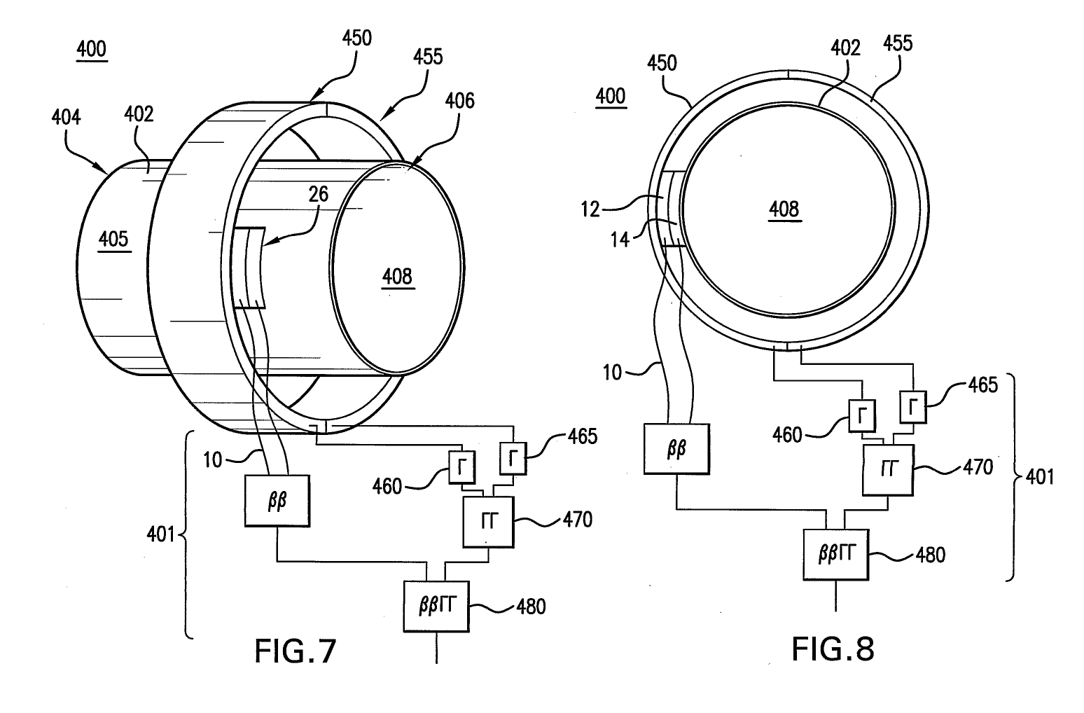

FIGS. 7 and 8 depict a flow cell 400 which incorporates a coincidence beta-beta-gamma-gamma detector 401 of the present invention. Detector 401 incorporates detector 10 as part thereof. Flow cell 400 includes an elongate conduit 402 having first open end 404, second open end 406 and defines an elongate passageway 408 extending therebetween. Flow-cell 400 may be placed in fluid communication with a source of blood, or any other fluid to be studied, so as to allow the blood (or alternate fluid) to flow through passageway 408 towards its final destination. Conduit 402 includes a cylindrical outer surface 405. Additionally, conduit 402 is desirably formed from a material which is transmissive to both beta and gamma radiation. Planar face 26 of Detector 10 is positioned against surface 405 for detecting beta particles emitted from the fluid flowing through passageway 408.

Detector 401 includes first and second semi-annular scintillators 450 and 455 extending fully about diodes 12 and 14 of detector 10 and conduit 402. Scintillators 450 and 455 are optically coupled to light-sensitive devices 460 and 465, respectively. Devices 460 and 465 are desirably formed from a photo-multiplier or a semi-conducting diode. Light-sensitive devices 460 and 465 convert the optical signal from scintillators 450 and 455, respectively, into first and second electrical signals which may be detected by a coincidence unit 470. The output of coincidence unit 470, indicating a gamma signal has been received from each of scintillators 450 and 455 within a predetermined time window, is provided to a coincidence unit 480. Coincidence unit 480 is also connected to the output of detector 10 so that it can detect the thresholded outputs of detector 10 and devices 460 and 465 within a time window so as to provide an output signal indicating the beta-beta output of detector 10 and the gamma-gamma signal from device 470. Scintillators 450 and 455 may alternatively be provided about only a portion of conduit 302.

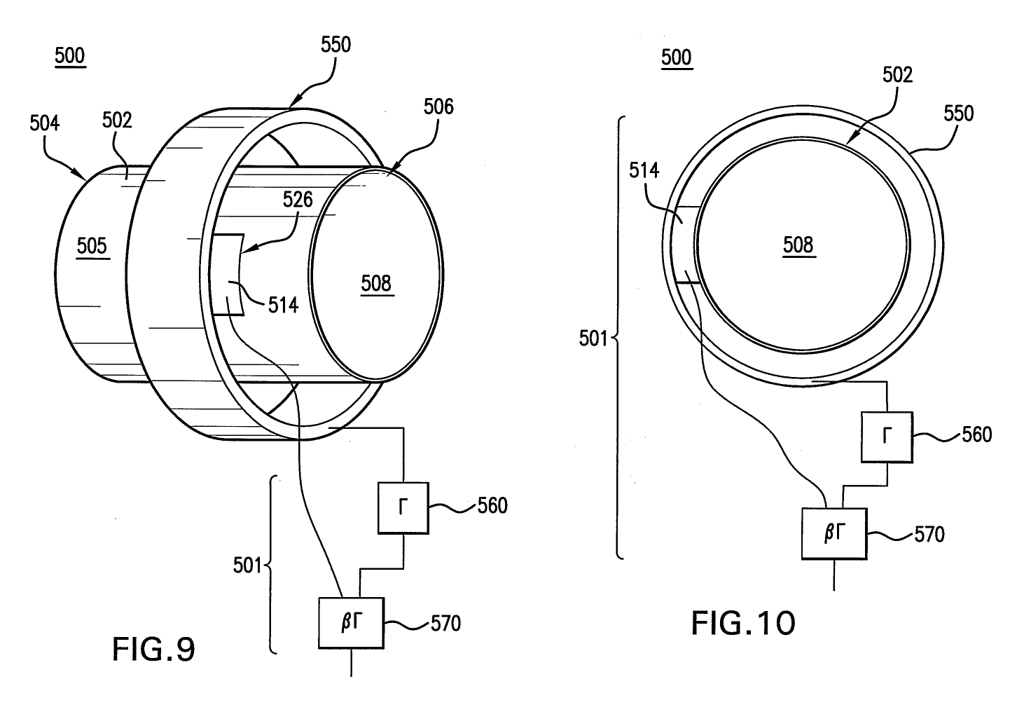

FIGS. 9 and 10 depict a flow cell 500 incorporating a coincidence beta-gamma detector 501 of the present invention. Flow cell 500 includes an elongate conduit 502 having first open end 504, second open end 506 and defines an elongate passageway 508 extending therebetween. Flow-cell 500 may be placed in fluid communication with a source of blood, or any other fluid to be studied, so as to allow the blood (or alternate fluid) to flow through passageway 508 towards its final destination. Conduit 502 includes a cylindrical outer surface 505. Conduit 502 is desirably formed from a material which is transmissive to both beta and gamma radiation. The planar face 526 of a single diode detector 514 is positioned against surface 505 for detecting beta particles emitted from the fluid flowing through passageway 508.

Detector 501 includes an annular scintillator 550 extending about diode 514 and conduit 502. Scintillator 550 is optically coupled to a light-sensitive device 560 such as a photo-multiplier or a semi-conducting diode. Light-sensitive device 560 converts the optical signal from scintillator 550 into an electrical signal which may be detected by a coincidence unit 570. Coincidence unit 570 is also connected to the output of diode 514 so that it can detect the outputs of diode 514 and device 560 within a time window so as to provide an output signal indicating the beta output of diode 514 and the gamma signal from device 560. Scintillator 550 may alternatively be provided about only a portion of conduit 502.

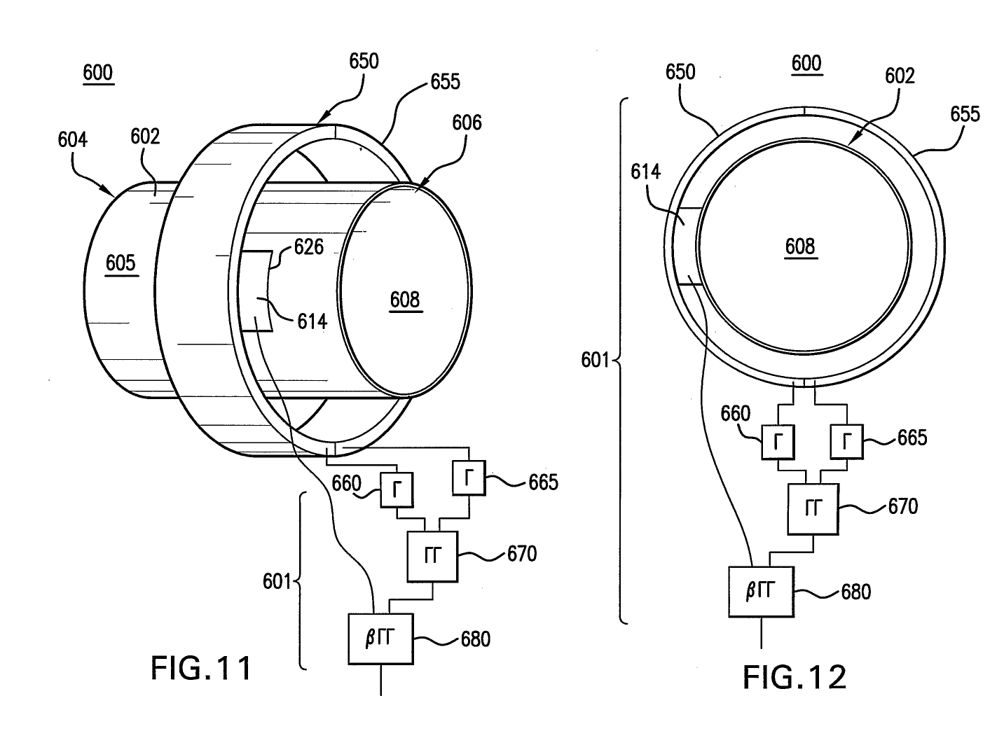

FIGS. 11 and 12 depict a flow cell 600 incorporating a coincidence beta-gamma-gamma detector 601 of the present invention. Flow cell 600 includes an elongate conduit 602 having first open end 604, second open end 606 and defines an elongate passageway 608 extending therebetween. Flow-cell 600 may be placed in fluid communication with a source of blood, or any other fluid to be studied, so as to allow the blood (or alternate fluid) to flow through passageway 608 towards its final destination. Conduit 602 includes a cylindrical outer surface 605. Additionally, conduit 602 is desirably formed from a material which is transmissive to both beta and gamma radiation. Planar face 626 of diode 614 is positioned against surface 605 for detecting beta particles emitted from the fluid flowing through passageway 608.

Detector 601 includes first and second semi-annular scintillators 650 and 655 extending fully about diode 614 and conduit 602. Scintillators 650 and 655 are optically coupled to light-sensitive devices 660 and 665, respectively. Devices 660 and 665 are desirably formed from a photo-multiplier or a semi-conducting diode. Light-sensitive devices 660 and 665 convert the optical signal from scintillators 650 and 655, respectively, into first and second electrical signals which may be detected by a coincidence unit 670. The output of coincidence unit 670 is provided to a coincidence unit 680. Coincidence unit 680 is also connected to the output of diode 614 so that it can detect the output of diode 614 and coincidence unit 670 within a time window so as to provide an output signal indicating the beta output of diode 614 and the gamma-gamma signal from device 670. Scintillators 650 and 655 may alternatively be provided about only a portion of conduit 602.

In FIGS. 5-12, each of the scintillators of the present invention are shown to conformally engage the diode thereadjacent. It will be appreciated by those of skill in the art that the present invention also contemplates that the adjacent diode need not conform to the interior surface of the scintillator. For example, each of these diodes may include a flat planar surface as shown by surface 20 in FIG. 1.

While each of the positron detectors of the present invention have been shown to extend about a relatively small portion of the conduit to which it is adjacent, it is further that each of the detectors may cover larger such radials of the conduit. For example, the positron detectors could extend to be fully annular about the conduit. Alternatively, multiple positron detectors may be provided to cover more of the conduit circumference, such detectors also being coupled in parallel.

While the particular embodiment of the present invention has been shown and described, it will be obvious to those skilled in the art that changes and modifications may be made without departing from the teachings of the invention. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. A beta radiation detection device for coupling to a fluid conduit, said detection device comprising:
First and second adjacent beta radiation detectors; and
a coincidence counter unit, each of said first and second detectors being coupled to said coincidence counter unit.

2. The detection device of claim 1, wherein:
said first detector comprises a first semi-conducting diode having a first and second opposed major surface, and
said second detector comprises a second semi-conducting diode having a first and second opposed major surface, said first and second diodes positioned in overlying registry at one of said first and second major surfaces.

3. The detection device of claim 1, wherein:
said first detector comprises a first semi-conducting transistor having a first and second opposed major surface, and
said second detector comprises a second semi-conducting transistor having a first and second opposed major surface, said first and second transistors positioned in overlying registry at one of said first and second major surfaces.

4. The detection device of claim 1, wherein the thickness of said first and second diodes is on between about 0.01 millimeter to about 2.00 millimeters

5. The detection device of claim 1, wherein at least one of said first and second diodes further comprises one or more pieces of scintillating material attached to silicon.

6. The detection device of claim 1, wherein said coincidence unit registers the signal from a positron impacting one of said major surfaces of each of said first and second diode.

7. The detection device of claim 6, wherein said coincidence unit registers the signal from a beta particle impacting one of said major surfaces of each of said first and second diode.

8. The detection device of claim 7, wherein said coincidence unit registers the signal from a gamma photon impacting one of said major surfaces of each of said first and second diode.

9. The detection device of claim 1, wherein said first and second detectors are optically coupled to said coincidence counter.

10. A flow-cell for conducting a fluid comprising:
an elongate wall defining an elongate passageway; and
a detection device of claim 1.

11. The flow-cell of claim 10, wherein one of said diodes of said detection device forms a portion of said wall so as to contact a fluid flowing through said passageway.

12. A method for detecting beta-emitting radioactive decay in a fluid comprising the step of detecting the same beta particle at least two times.

13. A method for detecting beta-emitting radioactive decay in a fluid comprising the steps of detecting a positron and one or more gamma photons.

14. The method for detecting positron-emitting radioactive decay in a fluid of claim 12, further comprising the step of detecting a positron at least two times.

15. A detection device for both beta radiation and gamma radiation, said detection device comprising:
First and second beta detecting diodes arranged to at least partially overlap so that a single beta radiation particle may pass through and be detected by both said first and second diodes;
A first coincidence counter unit coupled to said first and second beta detecting diodes, said first coincidence detector providing a first output signal corresponding to the detection of a beta particle by both said first and second diodes;
An annular gamma radiation detector positioned about said first and second beta detecting diodes;
A light-sensitive device coupled to said gamma radiation detector, said gamma radiation detector providing a second output signal corresponding to the detection of a gamma particle by said gamma radiation detector;
A second coincidence counter unit coupled to said first coincidence counter unit and said light sensitive device so as to receive said respective output signals, said second coincidence counter unit providing a third output signal corresponding to receipt of said respective output signals.

16. A detection device of claim 15, wherein said annular gamma radiation detector further comprises a first and second semi-annular scintillator, a second light sensitive device, and a gamma coincidence counter unit, each said semi-annular scintillator providing an output signal to said light-sensitive device, wherein the output from said gamma coincidence counter unit is coupled to said second coincidence counter unit.

17. A detection device of claim 15, further comprising a section of hollow conduit onto which said diodes are mounted and about which said annular gamma radiation detector is positioned.

18. A detection device of claim 17, wherein said diodes further comprise arcuate bodies which conform about said hollow conduit.

19. A detector as depicted in and described for any of FIGS. 1-12.
